(19) United States
(12) Patent Application Publication
(10) Pub. No.: US 2020/0241695 A1
(43) Pub. Date: Jul. 30, 2020

(54) POSITION DETECTING METHOD, POSITION DETECTING DEVICE, AND INTERACTIVE PROJECTOR

(71) Applicant: SEIKO EPSON CORPORATION, Tokyo (JP)

(72) Inventors: Akira IKEDA, Chino-shi (JP); Makoto OTANI, Matsumoto-shi (JP)

(73) Assignee: SEIKO EPSON CORPORATION, Tokyo (JP)

(21) Appl. No.: 16/775,686

(22) Filed: Jan. 29, 2020

(30) Foreign Application Priority Data
Jan. 30, 2019 (JP) 2019-014287

(51) Int. Cl. G06F 3/042

(52) U.S. Cl. CPC G06F 3/0421

(57) ABSTRACT

A position detecting method includes (a) imaging, using a first camera and a second camera, a pointer over an operation surface as a background to capture a first captured image and a second captured image, (b) creating a first calibration image and a second calibration image by performing stereo calibration on the first captured image and the second captured image, (c) extracting a first region of interest image and a second region of interest image from the first calibration image and the second calibration image, (d) creating a correlation image from the first region of interest image and the second region of interest image, and (e) determining a distance-related parameter related to a distance between the operation surface and the pointer using a convolutional neural network including an input layer to which the correlation image is input and an output layer that outputs the distance-related parameter.

The present application is based on, and claims priority from JP Application Serial Number 2019-014287, filed Jan. 30, 2019, the disclosure of which is hereby incorporated by reference herein in its entirety.

### BACKGROUND

### 1. Technical Field

The present disclosure relates to a technique for detecting the position of a pointer.

### 2. Related Art

JP A-2016-184850 (Patent Literature 1) discloses a projector capable of projecting a projection screen onto a screen, capturing, with a camera, an image including a pointer such as a finger, and detecting the position of the pointer using the captured image. When the tip of the pointer is in contact with the screen, the projector recognizes that a predetermined instruction for drawing or the like is input to the projection screen and draws the projection screen again according to the instruction. Therefore, a user is capable of inputting various instructions using the projection screen as a user interface. The projector of the type that can use the projection screen on the screen as the user interface, with which the user is capable of inputting instructions, in this way is called “interactive projector”. A screen surface functioning as a surface used to input instructions using the pointer is called “operation surface” as well. The position of the pointer is determined by triangulation using a plurality of images captured by a plurality of cameras.

However, in the related art, detection accuracy of the distance between the pointer and the operation surface and other distance-related parameters related to the distance is not always sufficient. Therefore, there has been demands for improvement of the detection accuracy of the distance-related parameters related to the distance between the pointer and the operation surface.

### SUMMARY

According to an aspect of the present disclosure, there is provided a position detecting method for detecting a parameter related to a position of a pointer with respect to an operation surface. The position detecting method includes: (a) imaging, using a first camera, the pointer over the operation surface as a background to capture a first captured image, and imaging, using a second camera disposed in a position different from a position of the first camera, the pointer over the operation surface as the background to capture a second captured image; (b) creating a first calibration image and a second calibration image by performing stereo calibration on the first captured image and the second captured image; (c) extracting a first region of interest image and a second region of interest image, each including the pointer, from the first calibration image and the second calibration image; (d) creating, by calculating, concerning each of the first region of interest image and the second region of interest image, a correlation value of a first kernel region and a second kernel region having corresponding pixels respectively as reference positions, a correlation image having the correlation value as a pixel value; and (e) determining a distance-related parameter related to a distance between the operation surface and the pointer using a convolutional neural network including an input layer to which the correlation image is input and an output layer that outputs the distance-related parameter.

The present disclosure can also be realized in a form of a position detecting device and can be realized in various forms other than the position detecting method and the position detecting device. The present disclosure can be realized in various forms such as an interactive projector, a computer program for realizing functions of the method or the device, and a non-transitory recording medium having the computer program recorded therein.

### BRIEF DESCRIPTION OF THE DRAWINGS

FIG. 1 is a perspective view of an interactive projection system in a first embodiment.

FIG. 2 is a side view of the interactive projection system.

FIG. 3 is a front view of the interactive projection system.

FIG. 4 is a functional block diagram of an interactive projector.

FIG. 5 is a flowchart showing a procedure of position detection processing.

FIG. 6 is an explanatory diagram showing processing content of steps S100 to S400 in FIG. 5.

FIG. 7 is a flowchart showing a procedure of imaging processing in step S100.

FIG. 8 is an explanatory diagram showing content of the imaging processing.

FIG. 9 is an explanatory diagram showing a configuration example of a convolutional neural network.

FIG. 10 is a graph showing a relation between the distance between an operation surface and a pointer and a representative correlation value.

FIG. 11 is a front view of a position detecting system in a second embodiment.

FIG. 12 is a functional block diagram of the position detecting system.

### DESCRIPTION OF EXEMPLARY EMBODIMENTS

### A. First Embodiment

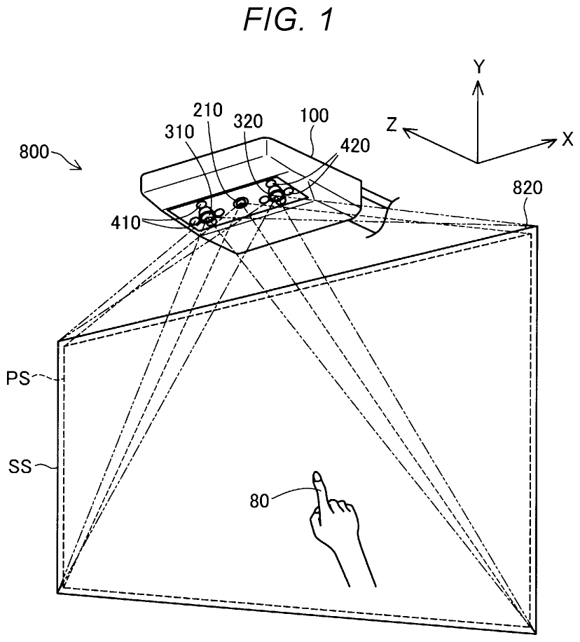

FIG. 1 is a perspective view of an interactive projection system 800 in a first embodiment. The system 800 includes an interactive projector 100 and a screen plate 820. The front surface of the screen plate 820 is used as an operation surface SS used to input an instruction using a pointer 80. The operation surface SS is also used as a projection surface on which a projection screen PS is projected. The projector 100 is fixed to a wall surface and set in the front of and above the screen plate 820. Although the operation surface SS is vertically disposed in FIG. 1, the system 800 can also be used with the operation surface SS disposed horizontally. In FIG. 1, the forward direction of the screen plate 820 is a Z direction, the upward direction of the screen plate 820 is a Y direction, and the right direction of the screen plate 820 is an X direction. For example, with Z=0, a position in a plane of the operation surface SS can be detected in a two-dimensional coordinate system (X, Y).

The projector 100 includes a projection lens 210 that projects an image onto the screen plate 820, two cameras 310 and 320 that capture images including the pointer 80, and two illuminating sections 410 and 420 that irradiate infrared lights for detecting the pointer 80, the two illuminating sections 410 and 420 corresponding to the two cameras 310 and 320.

The projection lens 210 projects the projection screen PS onto the operation surface SS. The projection screen PS includes an image drawn in the projector 100. When an image drawn in the projector 100 is absent, light is irradiated on the projection screen PS from the projector 100 and a white image is displayed. In this specification, the “operation surface SS” means a surface used to input an instruction using the pointer 80. The “projection screen PS” means a region of an image projected onto the operation surface SS by the projector 100.

In the system 800, one or a plurality of non-light emitting pointers 80 are usable. As the pointer 80, non-light emitting objects such as a finger and a pen are usable. A tip portion for an instruction of the non-light emitting pointer 80 is desirably excellent in a characteristic for reflecting infrared light and has a retroreflection characteristic.

A first camera 310 and a second camera 320 are respectively set to be capable of imaging the entire operation surface SS and have a function of respectively capturing images of the pointer 80 over the operation surface SS as a background. That is, the first camera 310 and the second camera 320 create images including the pointer 80 by receiving lights reflected on the operation surface SS and the pointer 80 in the infrared lights irradiated from a first illuminating section 410 and a second illuminating section 420. When two images captured by the first camera 310 and the second camera 320 are used, a three-dimensional position of the pointer 80 can be calculated by triangulation or the like. The number of cameras may be three or more.

The first illuminating section 410 has a function of a peripheral illuminating section that illuminates the periphery of an optical axis of the first camera 310 with infrared light. In the example shown in FIG. 1, the first illuminating section 410 includes four illuminating elements disposed to surround the periphery of the first camera 310. The first illuminating section 410 is configured such that a shadow of the pointer 80 due to the first illuminating section 410 is not substantially formed when an image of the pointer 80 is captured by the first camera 310. “A shadow is not substantially formed” means that the shadow of the pointer 80 is so thin as to not affect processing for calculating a three-dimensional position of the pointer 80 using the image. The second illuminating section 420 has the same configuration and the same function as the configuration and the function of the first illuminating section 410 and has a function of a peripheral illuminating section that illuminates the periphery of an optical axis of the second camera 320 with infrared light.

The number of illuminating elements configuring the first illuminating section 410 is not limited to four and may be any number equal to or larger than two. However, a plurality of illuminating elements configuring the first illuminating section 410 are desirably disposed in rotationally symmetrical positions centering on the first camera 310. The first illuminating section 410 may be configured using a ring-like illuminating element instead of using the plurality of illuminating elements. Further, a coaxial illuminating section that emits infrared light through a lens of the first camera 310 may be used as the first illuminating section 410. These modifications are applicable to the second illuminating section 420 as well. When, with N set to an integer equal to or larger than 2, N cameras are provided, peripheral illuminating sections or coaxial illuminating sections are desirably provided respectively for the cameras.

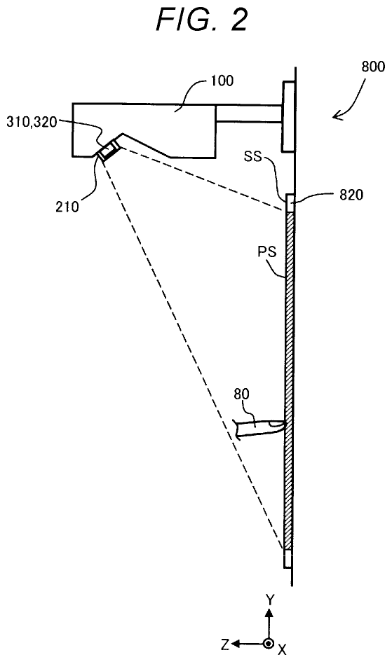

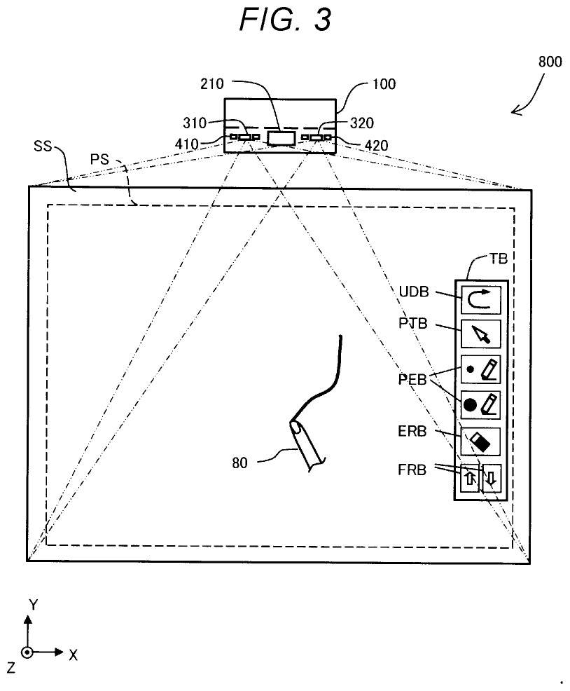

FIG. 2 is a side view of the interactive projection system 800. FIG. 3 is a front view of the interactive projection system 800. In this specification, a direction from the left end to the right end of the operation surface SS is defined as an X direction, a direction from the lower end to the upper end of the operation surface SS is defined as a Y direction, and a direction along the normal of the operation surface SS is defined as a Z direction. For convenience, the X direction is referred to as “width direction” as well, the Y direction is referred to as “upward direction” as well, and the Z direction is referred to as “distance direction” as well. In FIG. 2, for convenience of illustration, hatching is applied to a range of the projection screen PS in the screen plate 820. A coordinate position of the operation surface SS onto which the projection screen PS is projected can be detected as, for example, with Z=0, a two-dimensional coordinate of a two-dimensional coordinate system (X, Y). A two-dimensional coordinate system (V, U) of a captured image of the first camera 310 and a two-dimensional coordinate system (η, ξ) of a captured image of the second camera 320 are different from each other because of the dispositions and characteristics of the first camera 310 and the second camera 320 and are also different from the coordinate system (X, Y) of the projection screen PS and the operation surface SS. These coordinate systems are associated by calculating a conversion coefficient or the like with calibration processing.

An example shown in FIG. 3 shows a state in which the interactive projection system 800 is operating in a white board mode. The white board mode is a mode in which the user can optionally draw on the projection screen PS using the pointer 80. The projection screen PS including a tool box TB is projected on the operation surface SS. The tool box TB includes an undo button UDB for resetting processing, a pointer button PTB for selecting a mouse pointer, a pen button PEB for selecting a pen tool for drawing, an eraser button ERB for selecting an eraser tool for erasing a drawn image, and a front/rear button FRB for advancing or returning a screen. By clicking the buttons using the pointer 80, the user is capable of performing processing corresponding to the buttons and selecting tools corresponding to the buttons. Immediately after a start of the system 800, the mouse pointer may be selected as a default tool. In the example shown in FIG. 3, a state is drawn in which, after selecting a pen tool, the user moves the tip portion of the pointer 80 in the projection screen PS in a state in which the tip portion of the pointer 80 is in contact with the operation surface SS, whereby a line is drawn in the projection screen PS. The drawing of the line is performed by a projection-image creating section explained below.

The interactive projection system 800 is also operable in modes other than the white board mode . For example, the system 800 is also operable in a PC interactive mode for displaying, on the projection screen PS, an image of data transferred from a not-shown personal computer via a communication line. In the PC interactive mode, an image of data of spreadsheet software or the like is displayed. Input, creation, correction, and the like of data can be performed using various tools and icons displayed in the image.

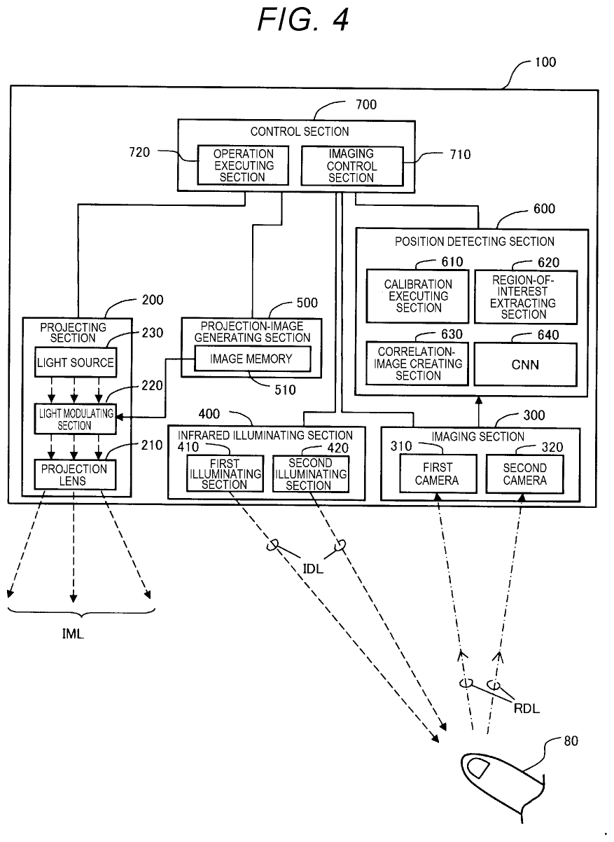

FIG. 4 is a functional block diagram of the interactive projector 100. The projector 100 includes a control section 700, a projecting section 200, a projection-image generating section 500, a position detecting section 600, an imaging section 300, and an infrared illuminating section 400. The imaging section 300 includes the first camera 310 and the second camera 320. The infrared illuminating section 400 includes the first illuminating section 410 and the second illuminating section 420.

The control section 700 performs control of the sections of the projector 100. The control section 700 has a function of an imaging control section 710 that acquires an image of the pointer 80 using the imaging section 300 and the infrared illuminating section 400. Further, the control section 700 has a function of an operation executing section 720 that recognizes content of an instruction performed on the projection screen PS by the pointer 80 detected by the position detecting section 600 and instructs the projection-image generating section 500 to create or change a projection image according to the content of the instruction.

The projection-image generating section 500 includes an image memory 510 that stores a projection image. The projection-image generating section 500 has a function of generating a projection image to be projected onto the operation surface SS by the projecting section 200. The projection-image generating section 500 desirably further has a function of a keystone correction section that corrects trapezoidal distortion of the projection screen PS.

The projecting section 200 has a function of projecting the projection image generated by the projection-image generating section 500 onto the operation surface SS. The projecting section 200 includes a light modulating section 220 and a light source 230 besides the projection lens 210 explained with reference to FIG. 2. The light modulating section 220 forms projection image light IML by modulating light from the light source 230 according to projection image data given from the image memory 510. The projection image light IML is typically color image light including visible lights of three colors of RGB and is projected onto the operation surface SS by the projection lens 210. As the light source 230, various light sources such as a light emitting diode and a laser diode can be adopted besides alight source lamp such as an ultrahigh pressure mercury lamp. As the light modulating section 220, a liquid crystal panel, a digital mirror device, and the like of a transmission type or a reflection type can be adopted. The projecting section 200 may include a plurality of light modulating sections 220 for each of color lights.

The infrared illuminating section 400 includes the first illuminating section 410 and the second illuminating section 420 explained with reference to FIG. 1. The first illuminating section 410 and the second illuminating section 420 are capable of respectively irradiating, on the operation surface SS and a space in front of the operation surface SS, illumination detection light IDL for detecting the tip portion of the pointer 80. The irradiation detection light IDL is infrared light. As explained below, the first illuminating section 410 and the second illuminating section 420 are lit at exclusive timings.

The imaging section 300 includes the first camera 310 and the second camera 320 explained with reference to FIG. 2. The two cameras 310 and 320 have a function of receiving light in a wavelength region including a wavelength of the irradiation detection light IDL and imaging the light. In an example shown in FIG. 4, a state is drawn in which the irradiation detection light IDL irradiated by the infrared illuminating section 400 is reflected by the pointer 80 and reflected detection light RDL of the irradiation detection light IDL is received and imaged by the two cameras 310 and 320.

The position detecting section 600 has a function of calculating a position of the tip portion of the pointer 80 using a first captured image captured and acquired by the first camera 310 and a second captured image captured and acquired by the second camera 320. The position detecting section 600 includes a calibration executing section 610, a region-of-interest extracting section 620, a correlation-image creating section 630, and a convolutional neural network 640. These sections may be stored in a storage region of the position detecting section as models. The calibration executing section 610 creates a first calibration image and a second calibration image, which are two calibration images, by performing stereo calibration on the first captured image and the second captured image, which are the two images captured by the two cameras 310 and 320. The region-of-interest extracting section 620 extracts, from the two calibration images, a first region of interest image and a second region of interest image, which are two region of interest images, each including the pointer 80. The correlation-image creating section 630 creates a correlation image explained below from the two region of interest images. The convolutional neural network 640 is configured to include an input layer to which the correlation image is input and an output layer that outputs a distance-related parameter related to the distance between the operation surface SS and the pointer 80. Details of functions of the sections 610 to 640 are explained below.

Functions of the sections of the control section 700 and functions of the sections of the position detecting section 600 are realized by, for example, a processor in the projector 100 executing computer programs. A part of the functions of the sections may be realized by a hardware circuit such as an FPGA (field-programmable gate array).

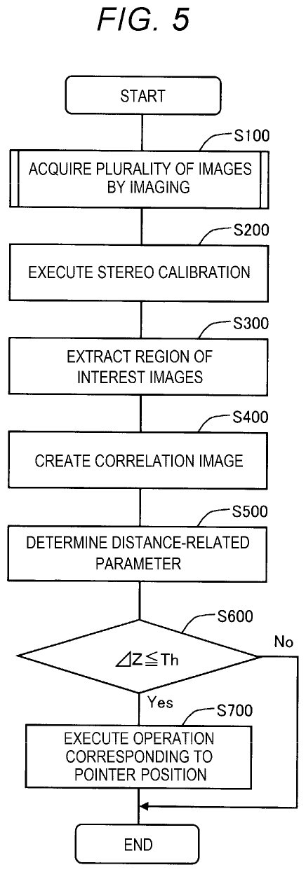

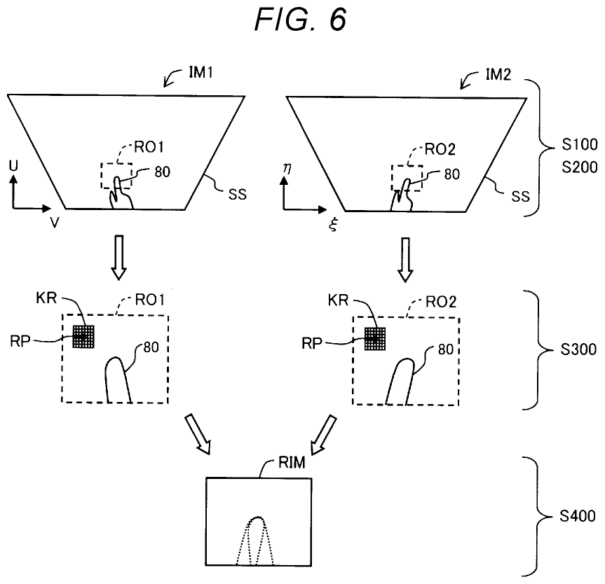

FIG. 5 is a flowchart showing a procedure of position detection processing in the embodiment. FIG. 6 is an explanatory diagram showing processing content of steps S100 to S400 in FIG. 5. This processing is repeatedly executed during the operation of the interactive projection system 800.

In step S100, the imaging section 300 acquires a plurality of images by imaging the pointer 80 over the operation surface SS as the background.

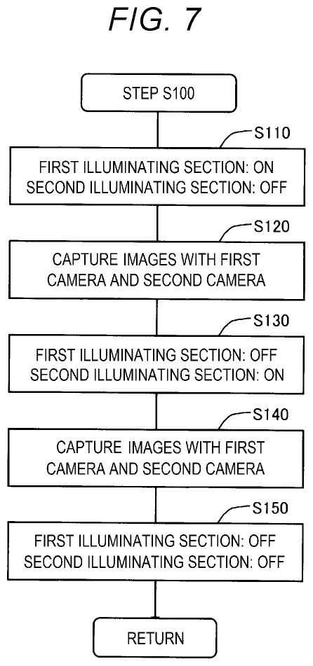

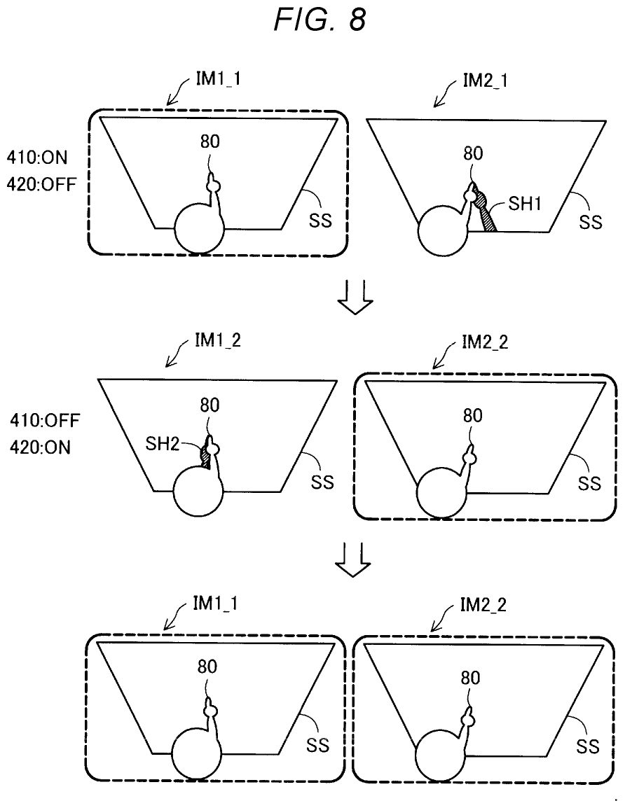

FIG. 7 is a flowchart showing a procedure of imaging processing in step S100 in FIG. 5. FIG. 8 is an explanatory diagram showing content of the imaging processing. First images IM1_1 and IM1_2 are indicated by the two-dimensional coordinate system (U, V) captured by the first camera 310. Second images IM2_1 and IM2_2 are indicated by the two-dimensional coordinate system (η, ξ) captured by the second camera 320. The procedure shown in FIG. 7 is executed under control by the imaging control section 710.

In step S110, the imaging control section 710 turns on the first illuminating section 410 and turns off the second illuminating section 420. In step S120, the imaging control section 710 captures images using the first camera 310 and the second camera 320. As a result, the first image IM1_1 and the second image IM2_1 shown in an upper part of FIG. 8 are acquired. A broken line surrounding the periphery of the first image IM1_1 is added for emphasis. Both the images IM1_1 and IM2_1 are images including the pointer 80 over the operation surface SS as the background. As explained with reference to FIG. 1, the first illuminating section 410 is configured such that a shadow of the pointer 80 due to the first illuminating section 410 is not substantially formed when an image of the pointer 80 is captured by the first camera 310. Therefore, of the two images acquired in step S120, the first image IM1_1 is a captured image captured by the first camera 310 when the first illuminating section 410 is lit. The first image IM1_1 does not substantially include a shadow of the pointer 80. On the other hand, the second image IM2_1 is a captured image captured by the second camera 320 when the second illuminating section 420 is extinguished. The second image IM2_1 includes a shadow SH1 of the pointer 80. The second image IM2_1 may not be captured.

In step S130, the imaging control section 710 turns off the first illuminating section 410 and turns on the second illuminating section 420. In step S140, the imaging control section 710 captures images using the first camera 310 and the second camera 320. As a result, the first image IM1_2 and the second image IM2_2 shown in a middle part of FIG. 8 are acquired. The second illuminating section 420 is configured such that a shadow of the pointer 80 due to the second illuminating section 420 is not substantially formed when an image of the pointer 80 is captured by the second camera 320. Therefore, of the two images acquired in step S140, the second image IM2_2 is an image captured by the second camera 320 when the second illuminating section 420 is lit. The second image IM2_2 does not substantially include a shadow of the pointer 80. On the other hand, the first image IM1_2 is an image captured by the first camera 310 when the first illuminating section 410 is extinguished. The first image IM1_2 includes a shadow SH2 of the pointer 80. The first image IM1_2 may not be captured.

When the imaging in step S120 and step S140 ends, as shown in a lower part of FIG. 8, the first image IM1_1 not substantially having a shadow captured by the first camera 310 and the second image IM2_2 not substantially having a shadow captured by the second camera 320 are obtained. The first image IM1_1 is a first captured image and the second image IM2_2 is a second captured image. In step S150 in FIG. 7, the imaging control section 710 turns off the two illuminating sections 410 and 420, ends the processing in step S100, and stays on standby until the next imaging. Step S150 may be omitted. After ending the processing in FIG. 7, the imaging control section 710 may immediately resume the processing shown in FIG. 7.

When the processing in step S100 ends in this way, in step S200 in FIG. 5, the calibration executing section 610 creates two calibration images by performing stereo calibration on the two images IM1_1 and IM2_2 obtained in step S100. In this embodiment, as the “stereo calibration”, processing for adjusting a coordinate of one of the two images IM1_1 and IM2_2 is performed to eliminate a parallax on the operation surface SS. For example, when the first image IM1_1, which is the coordinate system (U, V), is set as a reference image and the second image IM2_2 is set as a comparative image to calculate a parallax, calibration can be performed to eliminate a parallax between the first image IM1_1 and the second image IM2_2 on the operation surface SS by adjusting the coordinate system (η, ξ) of the second image IM2_2 to the coordinate system (U, V). Calibration parameters such as a conversion coefficient necessary for the stereo calibration are determined in advance and set in the calibration executing section 610. Two images IM1 and IM2 shown in an upper part of FIG. 6 indicate two calibration images after the stereo calibration. However, the pointer 80 is drawn to be simplified in the calibration images IM1 and IM2. With the projection screen PS, which is the (X, Y) coordinate system, set as a reference image, the respective calibration images IM1 and IM2 of the first image IM1_1 captured by the first camera 310 and the second image IM2_2 captured by the second camera 320 may be created to perform the stereo calibration. In this case, a calibration parameter for converting the two-dimensional coordinate system (U, V) of the first image IM1 into the two-dimensional coordinate system (X, Y) of the projection image PS and a calibration parameter for converting the two-dimensional coordinate system (η, ξ) of the second image IM2 into the two-dimensional coordinate system (X, Y) of the projection image PS are determined in advance and set in the calibration executing section 610.

Instead of setting illumination periods for the two illuminating sections 410 and 420 at the exclusive timings different from each other and sequentially capturing images in the respective illumination periods as explained with reference to FIGS. 7 and 8, the stereo calibration may be executed using two images captured at the same timing by the two cameras 310 and 320. In this case, the two illuminating sections 410 and 420 explained with reference to FIG. 1 do not need to be provided. It is sufficient to provide one illuminating section used in common to the two cameras 310 and 320. However, in the imaging method explained with reference to FIGS. 7 and 8, the two images IM1_1 and IM2_2 not substantially having a shadow are obtained. Therefore, there is an advantage that processing explained below can be more accurately performed.

In step S300 in FIG. 5, the region-of-interest extracting section 620 extracts region of interest images RO1 and RO2 respectively from the two calibration images IM1 and IM2. As shown in upper and middle parts of FIG. 6, the region of interest images RO1 and RO2 are images of a region including the tip portion of the pointer 80 and are images extracted as targets of later processing. Extraction processing of the region of interest images RO1 and RO2 can be executed using publicly-known various kinds of image processing such as a background difference method, an average background difference method, binarization, morphology conversion, edge detection, and convex hull detection. Each of the region of interest images RO1 and RO2 is extracted as, for example, a square image centering on the tip portion of the pointer 80 and having 100 to 300 pixels on one side.

In step S400, the correlation-image creating section 630 creates a correlation image RIM from the two region of interest images RO1 and RO2. A pixel value of the correlation image RIM is obtained by calculating, with the following expression, a correlation value p of two kernel regions KR having corresponding pixels respectively as reference positions RP in the two region of interest images RO1 and RO2 as shown in the middle part of FIG. 6. That is, the correlation image RIM is an image having, as a pixel value, the correlation value p calculated according to Expressions (1a) to (1d):

$$\begin{matrix}p = \frac{{σ}_{p q}}{{σ}_{p} {σ}_{q}} & ( 1 a ) \\ {σ}_{{p}^{2}} = \frac{1}{m} {\sum }_{i = 1}^{m} {( {P}_{i} - {μ}_{p} )}^{2} & ( 1 b ) \\ {σ}_{{q}^{2}} = \frac{1}{m} {\sum }_{i = 1}^{m} {( {Q}_{i} - {μ}_{q} )}^{2} & ( 1 c ) \\ {σ}_{p q} = \frac{1}{m} {\sum }_{i = 1}^{m} ( {P}_{i} - {μ}_{p} ) ( {Q}_{i} - {μ}_{q} ) & ( 1 d )\end{matrix}$$

where, Pᵢ is a pixel value of the first calibration image IM1, Qᵢ is a pixel value of the second calibration image IM2, μₚ is an average of pixel values in a first kernel region KR of the first calibration image IM1, μ_{q} is an average of pixel values in a second kernel region KR of the second calibration image IM2, m is the number of pixels of one side of the kernel region KR, σₚ and σ_{q} are variances, and σ_{pq} are covariance. The averages μₚ and μ_{q} are calculated using a publicly-known averaging method such as a simple average or a Gaussian average.

The correlation value ρ given by the above Expressions (1a) to (1d) is a so-called correlation coefficient and means similarity of the two calibration images IM1 and IM2 in the kernel region KR. That is, a larger positive correlation value ρ means that the similarity of the two calibration images IM1 and IM2 in the kernel region KR is higher and a parallax is smaller. Therefore, it is possible to determine the distance-related parameter related to the distance between the operation surface SS and the pointer 80 using the correlation image RIM.

A value other than the correlation coefficient can be used as the correlation value ρ. For example, an SAD (Sum of Absolute Difference) or an SSD (Sum of Squared Difference) may be used as the correlation value ρ. Preprocessing such as normalization and smoothing is desirably performed on the first calibration image IM1 and the second calibration image IM2 before the correlation image RIM is created.

In step S500 in FIG. 5, the convolutional neural network 640 determines the distance-related parameter from the correlation image RIM. In the first embodiment, the distance itself between the operation surface SS and the pointer 80 is used as the distance-related parameter.

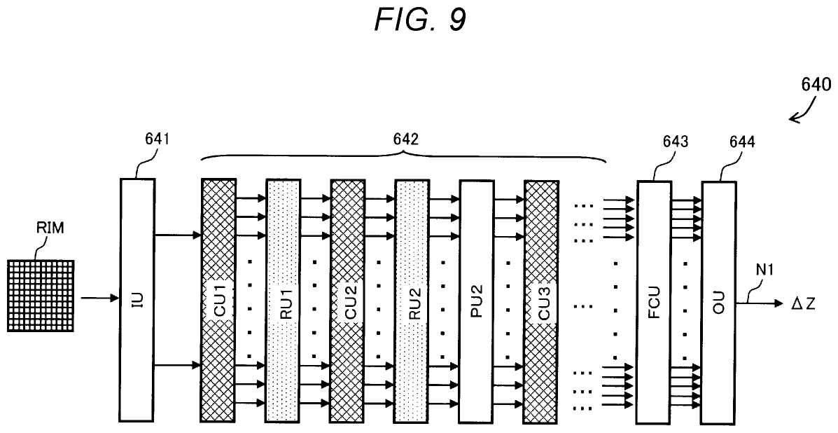

FIG. 9 is an explanatory diagram showing a configuration example of the convolutional neural network 640. The convolutional neural network 640 includes an input layer 641, an intermediate layer 642, a fully coupled layer 643, and an output layer 644. The correlation image RIM obtained in step S400 is input to the input layer 641. The intermediate layer 642 includes convolutional layers CU1, CU2, CU3, normalization layers RU1, RU2, and pooling layers PU2. The combination and the disposition of the convolutional layers, the normalization layers, and the pooling layers are examples. Various combinations and dispositions other than this are possible. A plurality of feature values corresponding to the correlation image RIM are output from the intermediate layer 642 and input to the fully coupled layer 643. The fully coupled layer 643 may include a plurality of fully coupled layers. A distance ΔZ between the operation surface SS and the pointer 80 is output from an output node N1 of the output layer 644 as the distance-related parameter.

The distance-related parameter can be determined using the convolutional neural network 640 because the distance-related parameter has a positive or negative correlation with a feature value of the correlation image RIM. As the feature value having the correlation with the distance-related parameter, there is a statistical representative value of the correlation value ρ in the correlation image RIM. An average, a maximum, a median, and the like correspond to the statistical representative value. In the following explanation, an average ρave of the correlation value ρ is used as an example of the statistical representative value of the correlation value ρ in the correlation image RIM. The statistical representative value ρave has a negative correlation with respect to the distance ΔZ between the operation surface SS and the pointer 80.

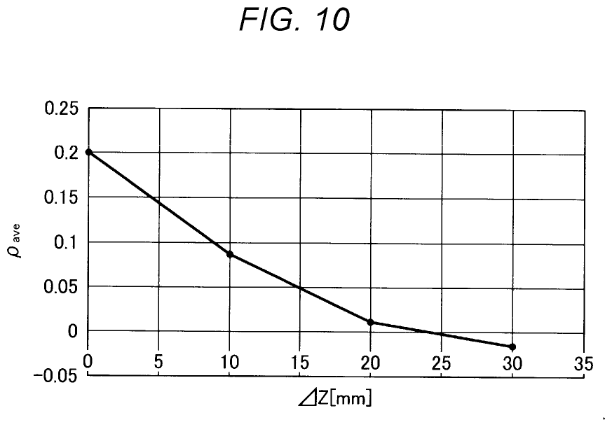

FIG. 10 is a graph showing a relation between the distance ΔZ between the operation surface SS and the pointer and the representative correlation value ρave. The horizontal axis of the figure indicates the distance ΔZ between the operation surface SS and the pointer 80 and the vertical axis of the figure indicates the representative correlation value ρave. The representative correlation value ρave decreases as the distance ΔZ increases. Such a representative correlation value ρave or a value similar to the representative correlation value ρave is calculated as one of feature values of the correlation image RIM in the intermediate layer 642 of the convolutional neural network 640 and input to the fully coupled layer 643. Therefore, it is possible to determine the distance ΔZ using the convolutional neural network 640 to which the correlation image RIM is input. During learning of the convolutional neural network 640, if causing the convolutional neural network 640 to learn a distance-related parameter other than the distance ΔZ, it is possible to obtain the distance-related parameter using the convolutional neural network 640.

In step S600 in FIG. 5, the operation executing section 720 determines whether the distance ΔZ between the operation surface SS and the pointer 80 is equal to or smaller than a preset threshold Th. If the distance ΔZ is equal to or smaller than the threshold Th, in step S700, the operation executing section 720 executes operation corresponding to the tip position of the pointer 80. The threshold Th is a value with which it can be determined that the tip of the pointer is extremely close to the operation surface SS. The threshold Th is set in a range of, for example, 3 to 5 mm. The operation in step S700 is processing on the operation surface SS such as the drawing explained with reference to FIG. 3. An XY coordinate of the tip position of the pointer 80 on the operation surface SS can be determined using a publicly-known method such as pattern matching or characteristic detection of the pointer 80 in the two calibration images IM1 and IM2.

In step S500, the distance ΔZ between the operation surface SS and the pointer 80 is determined as the distance-related parameter. However, a parameter other than the distance ΔZ may be calculated as the distance-related parameter. For example, when, from the feature values obtained according to the correlation image RIM, it can be assumed in step S500 that the distance ΔZ is sufficiently small, the operation in step S700 maybe immediately executed without calculating the distance ΔZ. In this case, the distance-related parameter is an operation execution parameter such as a flag or a command indicating execution of operation corresponding to the position of the pointer 80. With this configuration, in a situation in which the distance ΔZ between the pointer 80 and the operation surface SS is assumed to be sufficiently small, it is possible to execute operation on the operation surface SS using the pointer 80 without determining the distance ΔZ between the pointer 80 and the operation surface SS.

As explained above, in the first embodiment, the distance-related parameter related to the distance ΔZ between the operation surface SS and the pointer 80 is determined using the convolutional neural network 640 to which the correlation image is input and from which the distance-related parameter is output. Therefore, it is possible to accurately determine the distance-related parameter.

The number of cameras may be three or more. That is, with N set to an integer equal to or larger than 3, N cameras may be provided. In this case, the calibration executing section 610 creates N calibration images respectively captured by the N cameras. The region-of-interest extracting section 620 extracts N region of interest images, each including the pointer 80, from the N calibration images. With M set to an integer equal to or larger than 1 and equal to or smaller than {N (N−1)/2}, the correlation-image creating section 630 can create M correlation images from M sets of region of interest images, two of which are selected out of the N region of interest images. That is, the correlation-image creating section 630 is capable of creating, by calculating, concerning each of two region of interest images of each set, a correlation value of two kernel regions KR having corresponding pixels respectively as reference positions in the two region of interest images, the M correlation images having the correlation value as a pixel value. The input layer 641 of the convolutional neural network 640 is configured to input the M correlation images. With this configuration, since N images can be captured in a state in which a shadow of the pointer 80 is less on the operation surface, it is possible to accurately determine the distance-related parameter.

### B. Second Embodiment

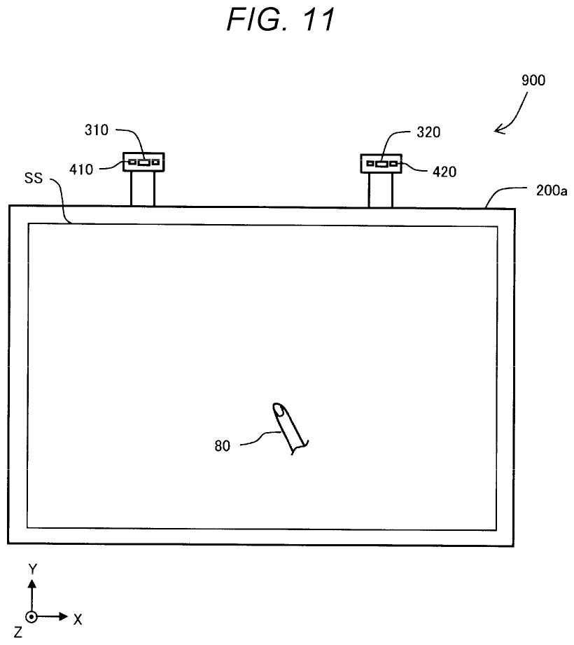

FIG. 11 is a front view of a position detecting system 900 in a second embodiment. The position detecting system 900 includes an image display panel 200a, the two cameras 310 and 320 that capture images including the pointer 80, and the two illuminating sections 410 and 420 that irradiate infrared lights for detecting the pointer 80. The configurations of the cameras 310 and 320 and the illuminating sections 410 and 420 are the same as the configurations of those in the first embodiment. The image display panel 200a is a so-called flat panel display. An image display surface of the image display panel 200a is equivalent to the operation surface SS.

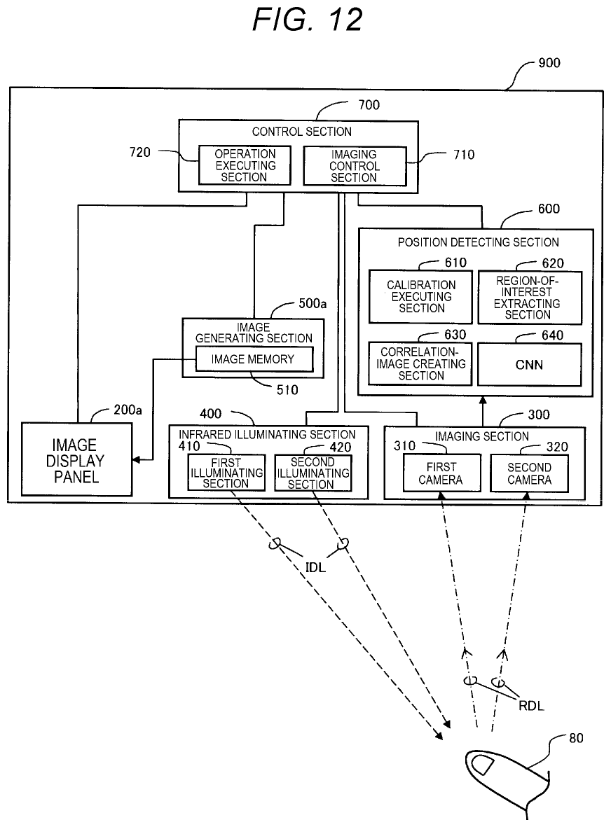

FIG. 12 is a functional block diagram of the position detecting system 900. In the position detecting system 900, among the components of the interactive projector 100 shown in FIG. 4, the projecting section 200 is changed to the image display panel 200a and the projection-image generating section 500 is changed to an image generating section 500a. The other components are the same as the components of the interactive projector 100. Position detection processing by the position detecting system 900 is the same as the processing in the first embodiment explained with reference to FIGS. 4 to 9. Therefore, explanation of the position detection processing is omitted. The second embodiment achieves the same effects as the effects in the first embodiment.

### C. Other Embodiments

The present disclosure is not limited to the embodiments explained above and can be realized in various forms in a range not departing from the gist of the present disclosure. For example, the present disclosure can also be realized by the following aspects. The technical features in the embodiments corresponding to technical features in the aspects described below can be substituted or combined as appropriate in order to solve a part or all of the problems of the present disclosure or in order to achieve a part or all of the effects of the present disclosure. If the technical features are not explained as essential technical features in this specification, the technical features can be deleted as appropriate.

(1) According to a first aspect of the present disclosure, there is provided a position detecting method for detecting a parameter related to a position of a pointer with respect to an operation surface. The position detecting method includes: (a) imaging, using a first camera, the pointer over the operation surface as a background to capture a first captured image, and imaging, using a second camera disposed in a position different from a position of the first camera, the pointer over the operation surface as the background to capture a second captured image; (b) creating a first calibration image and a second calibration image by performing stereo calibration on the first captured image and the second captured image; (c) extracting a first region of interest image and a second region of interest image, each including the pointer, from the first calibration image and the second calibration image; (d) creating, by calculating, concerning each of the first region of interest image and the second region of interest image, a correlation value of a first kernel region and a second kernel region having corresponding pixels respectively as reference positions, a correlation image having the correlation value as a pixel value; and (e) determining a distance-related parameter related to a distance between the operation surface and the pointer using a convolutional neural network including an input layer to which the correlation image is input and an output layer that outputs the distance-related parameter.

With the position detecting method, since the distance-related parameter related to the distance between the operation surface and the pointer is determined using the convolutional neural network to which the correlation image is input and from which the distance-related parameter is output, it is possible to accurately determine the distance-related parameter.

(2) In the position detecting method, in the (a), with N set to an integer equal to or larger than 3, the pointer over the operation surface as the background may be captured by N cameras to acquire N captured images, in the (b), N calibration images may be created by performing the stereo calibration on the N captured images, in the (c), N region of interest images, each including the pointer, maybe extracted from the N calibration images, in the (d), with M set to an integer equal to or larger than 1 and equal to or smaller than {N(N−1)/2}, by calculating, concerning each of M sets of two region of interest images, two of which are selected out of the N region of interest images, a correlation value of two kernel regions having corresponding pixels respectively as reference positions in the two region of interest images, M correlation images having the correlation value as a pixel value may be created, and in the (e), the distance-related parameter may be determined using a convolutional neural network including an input layer to which the M correlation images are input and an output layer that outputs the distance-related parameter.

With the position detecting method, since the distance-related parameter is determined using the three or more cameras, it is possible to more accurately determine the distance-related parameter.

(3) In the position detecting method, the distance-related parameter may be the distance between the operation surface and the pointer.

With the position detecting method, it is possible to accurately determine the distance between the operation surface and the pointer according to a statistical representative value of correlation values concerning a plurality of correlation images.

(4) In the position detecting method, the distance-related parameter may be an operation execution parameter indicating that operation on the operation surface corresponding to a position of the pointer is executed.

With the position detecting method, in a situation in which it is assumed that the distance between the pointer and the operation surface is sufficiently small, it is possible to execute the operation on the operation surface using the pointer without determining the distance between the pointer and the operation surface.

(5) In the position detecting method, the (a) may include: sequentially selecting a first infrared illuminating section provided to correspond to the first camera and a second infrared illuminating section provided to correspond to the second camera; and executing imaging using the first camera while performing illumination with the first infrared illuminating section without performing illumination with the second infrared illuminating section, executing imaging using the second camera while performing illumination with the second infrared illuminating section without performing illumination with the first infrared illuminating section, and sequentially acquiring the first captured image and the second captured image one by one at different timings, and the first infrared illuminating section and the second infrared illuminating section may be configured to include at least one of a coaxial illuminating section configured to perform coaxial illumination on the cameras and a peripheral illuminating section disposed to surround peripheries of optical axes of the cameras.

With this position detecting method, since the two captured images can be captured in a state in which a shadow of the pointer is less on the operation surface, it is possible to accurately determine the distance-related parameter.

(6) According to a second aspect of the present disclosure, there is provided a position detecting device that detects a parameter related to a position of a pointer with respect to an operation surface. The position detecting device includes: an imaging section including a first camera configured to image the pointer over the operation surface as a background to capture a first captured image and a second camera disposed in a position different from a position of the first camera and configured to image the pointer over the operation surface as the background to capture a second captured image; a calibration executing section configured to create a first calibration image and a second calibration image by performing stereo calibration on the first captured image and the second captured image; a region-of-interest extracting section configured to extract a first region of interest image and a second region of interest image, each including the pointer, from the first calibration image and the second calibration image; a correlation-image creating section configured to create, by calculating, concerning each of the first region of interest image and the second region of interest image, a correlation value of a first kernel region and a second kernel region having corresponding pixels respectively as reference positions, a correlation image having the correlation value as a pixel value; and a convolutional neural network including an input layer to which the correlation image is input and an output layer that outputs a distance-related parameter related to a distance between the operation surface and the pointer.

With the position detecting device, since the distance-related parameter related to the distance between the operation surface and the pointer is determined using the convolutional neural network to which the correlation image is input and from which the distance-related parameter is output, it is possible to accurately determine the distance-related parameter.

(7) In the position detecting device, with N set to an integer equal to or larger than 3, the imaging section may include N cameras configured to image the pointer over the operation surface as the background to acquire N captured images, the calibration executing section may create N calibration images by performing the stereo calibration on the N captured images, the region-of-interest extracting section may extract N region of interest images, each including the pointer, from the N calibration images, with M set to an integer equal to or larger than 1 and equal to or smaller than {N (N-1)/2}, the correlation-image creating section may create, by calculating, concerning each of M sets of region of interest images, two of which are selected out of the N region of interest images, a correlation value of two kernel regions having corresponding pixels respectively as reference positions in the two region of interest images, M correlation images having the correlation value as a pixel value, and the convolutional neural network may include an input layer to which the M correlation images are input and an output layer that outputs the distance-related parameter related to the distance between the operation surface and the pointer.

With the position detecting device, since the distance-related parameter is determined using the three or more cameras, it is possible to more accurately determine the distance-related parameter.

(8) In the position detecting device, the distance-related parameter may be the distance between the operation surface and the pointer.

With the position detecting device, it is possible to accurately determine the distance between the operation surface and the pointer according to a statistical representative value of correlation values concerning a plurality of correlation images.

(9) In the position detecting device, the distance-related parameter may be an operation execution parameter indicating that operation on the operation surface corresponding to a position of the pointer is executed.

With the position detecting device, in a situation in which it is assumed that the distance between the pointer and the operation surface is sufficiently small, it is possible to execute the operation on the operation surface using the pointer without determining the distance between the pointer and the operation surface.

(10) The position detecting device may further include: a first infrared illuminating section configured to include at least one of a coaxial illuminating section configured to perform coaxial illumination on the first camera and a peripheral illuminating section disposed to surround a periphery of an optical axis of the first camera; a second infrared illuminating section configured to include at least one of a coaxial illuminating section configured to perform coaxial illumination on the second camera and a peripheral illuminating section disposed to surround a periphery of an optical axis of the second camera; and an imaging control section configured to control imaging performed using the first camera and the first infrared illuminating section and the second camera and the second infrared illuminating section. The imaging control section may sequentially select the first camera and the first infrared illuminating section and the second camera and the second infrared illuminating section and sequentially acquire the first captured image and the second captured image at different timings by executing imaging using the first camera while performing illumination with the first infrared illuminating section without performing illumination with the second infrared illuminating section and executing imaging using the second camera while performing illumination with the second infrared illuminating section without performing illumination with the first infrared illuminating section.

With this position detecting device, since the two captured images can be captured in a state in which a shadow of the pointer is lesson the operation surface, it is possible to accurately determine the distance-related parameter.

(11) According to a third aspect of the present disclosure, there is provided an interactive projector that detects a parameter related to a position of a pointer with respect to an operation surface. The interactive projector includes: a projecting section configured to project a projection image onto the operation surface; an imaging section including a first camera configured to image the pointer over the operation surface as a background to capture a first captured image and a second camera disposed in a position different from a position of the first camera and configured to image the pointer over the operation surface as the background to capture a second captured image; a calibration executing section configured to create a first calibration image and a second calibration image by performing stereo calibration on the first captured image and the second captured image; a region-of-interest extracting section configured to extract a first region of interest image and a second region of interest image, each including the pointer, from the first calibration image and the second calibration image; a correlation-image creating section configured to create, by calculating, concerning each of the first region of interest image and the second region of interest image, a correlation value of a first kernel region and a second kernel region having corresponding pixels respectively as reference positions, a correlation image having the correlation value as a pixel value; and a convolutional neural network including an input layer to which the correlation image is input and an output layer that outputs a distance-related parameter related to a distance between the operation surface and the pointer.

With the interactive projector, since the distance-related parameter related to the distance between the operation surface and the pointer is determined using the convolutional neural network to which the correlation image is input and from which the distance-related parameter is output, it is possible to accurately determine the distance-related parameter.

What is claimed is:

1. A position detecting method for detecting a parameter related to a position of a pointer with respect to an operation surface, the position detecting method comprising:
(a) imaging, using a first camera, the pointer over the operation surface as a background to capture a first captured image, and imaging, using a second camera disposed in a position different from a position of the first camera, the pointer over the operation surface as the background to capture a second captured image;
(b) creating a first calibration image and a second calibration image by performing stereo calibration on the first captured image and the second captured image;
(c) extracting a first region of interest image and a second region of interest image, each including the pointer, from the first calibration image and the second calibration image;
(d) creating, by calculating, concerning each of the first region of interest image and the second region of interest image, a correlation value of a first kernel region and a second kernel region having corresponding pixels respectively as reference positions, a correlation image having the correlation value as a pixel value; and
(e) determining a distance-related parameter related to a distance between the operation surface and the pointer using a convolutional neural network including an input layer to which the correlation image is input and an output layer that outputs the distance-related parameter.

2. The position detecting method according to claim 1, wherein
in the (a), with N set to an integer equal to or larger than 3, the pointer over the operation surface as the background is imaged by N cameras to capture N captured images,
in the (b), N calibration images are created by performing the stereo calibration on the N captured images,
in the (c), N region of interest images, each including the pointer, are extracted from the N calibration images, in the (d), with M set to an integer equal to or larger than 1 and equal to or smaller than {N(N−1)/2}, by calculating, concerning each of M sets of two region of interest images selected out of the N region of interest images, a correlation value of two kernel regions having corresponding pixels respectively as reference positions in the two region of interest images, M correlation images having the correlation value as a pixel value are created, and
in the (e), the distance-related parameter is determined using the convolutional neural network including an input layer to which the M correlation images are input and an output layer that outputs the distance-related parameter.

3. The position detecting method according to claim 1, wherein the distance-related parameter is the distance between the operation surface and the pointer.

4. The position detecting method according to claim 1, wherein the distance-related parameter is an operation execution parameter indicating that operation on the operation surface corresponding to a position of the pointer is executed.

5. The position detecting method according to claim 1, wherein
the (a) includes:
sequentially selecting a first infrared illuminating section provided to correspond to the first camera and a second infrared illuminating section provided to correspond to the second camera; and
executing imaging using the first camera while performing illumination with the first infrared illuminating section without performing illumination with the second infrared illuminating section, executing imaging using the second camera while performing illumination with the second infrared illuminating section without performing illumination with the first infrared illuminating section, and sequentially acquiring the first captured image and the second captured image one by one at different timings, and
the first infrared illuminating section and the second infrared illuminating section are configured to include at least one of a coaxial illuminating section configured to perform coaxial illumination on the cameras and a peripheral illuminating section disposed to surround peripheries of optical axes of the cameras.

6. A position detecting device that detects a parameter related to a position of a pointer with respect to an operation surface, the position detecting device comprising:
an imaging section including a first camera configured to image the pointer over the operation surface as a background to capture a first captured image and a second camera disposed in a position different from a position of the first camera and configured to image the pointer over the operation surface as the background to capture a second captured image;
a calibration executing section configured to create a first calibration image and a second calibration image by performing stereo calibration on the first captured image and the second captured image;
a region-of-interest extracting section configured to extract a first region of interest image and a second region of interest image, each including the pointer, from the first calibration image and the second calibration image;
a correlation-image creating section configured to create, by calculating, concerning each of the first region of interest image and the second region of interest image, a correlation value of a first kernel region and a second kernel region having corresponding pixels respectively as reference positions, a correlation image having the correlation value as a pixel value; and
a convolutional neural network including an input layer to which the correlation image is input and an output layer that outputs a distance-related parameter related to a distance between the operation surface and the pointer.

7. The position detecting device according to claim 6, wherein, with N set to an integer equal to or larger than 3, the imaging section includes N cameras configured to image the pointer over the operation surface as the background to capture N captured images,
the calibration executing section creates N calibration images by performing the stereo calibration on the N captured images,
the region-of-interest extracting section extracts N region of interest images, each including the pointer, from the N calibration images,
with M set to an integer equal to or larger than 1 and equal to or smaller than {N(N−1)/2}, the correlation-image creating section creates, by calculating, concerning each of M sets of two region of interest images selected out of the N region of interest images, a correlation value of two kernel regions having corresponding pixels respectively as reference positions in the two region of interest images, M correlation images having the correlation value as a pixel value, and the convolutional neural network includes an input layer to which the M correlation images are input and an output layer that outputs the distance-related parameter related to the distance between the operation surface and the pointer.

8. The position detecting device according to claim 6, wherein the distance-related parameter is the distance between the operation surface and the pointer.

9. The position detecting device according to claim 6, wherein the distance-related parameter is an operation execution parameter indicating that operation on the operation surface corresponding to a position of the pointer is executed.

10. The position detecting device according to claim 6, further comprising:
a first infrared illuminating section configured to include at least one of a coaxial illuminating section configured to perform coaxial illumination on the first camera and a peripheral illuminating section disposed to surround a periphery of an optical axis of the first camera;
a second infrared illuminating section configured to include at least one of a coaxial illuminating section configured to perform coaxial illumination on the second camera and a peripheral illuminating section disposed to surround a periphery of an optical axis of the second camera; and
an imaging control section configured to control imaging performed using the first camera and the first infrared illuminating section and the second camera and the second infrared illuminating section, and
the imaging control section sequentially selects the first camera and the first infrared illuminating section and the second camera and the second infrared illuminating section and sequentially acquires the first captured image and the second captured image at different timings by executing imaging using the first camera while performing illumination with the first infrared illuminating section without performing illumination with the second infrared illuminating section and executing imaging using the second camera while performing illumination with the second infrared illuminating section without performing illumination with the first infrared illuminating section.

11. An interactive projector that detects a parameter related to a position of a pointer with respect to an operation surface, the interactive projector comprising:
a projecting section configured to project a projection image onto the operation surface;
an imaging section including a first camera configured to image the pointer over the operation surface as a background to capture a first captured image and a second camera disposed in a position different from a position of the first camera and configured to image the pointer over the operation surface as the background to capture a second captured image;
a calibration executing section configured to create a first calibration image and a second calibration image by performing stereo calibration on the first captured image and the second captured image;
a region-of-interest extracting section configured to extract a first region of interest image and a second region of interest image, each including the pointer, from the first calibration image and the second calibration image;
a correlation-image creating section configured to create, by calculating, concerning each of the first region of interest image and the second region of interest image, a correlation value of a first kernel region and a second kernel region having corresponding pixels respectively as reference positions, a correlation image having the correlation value as a pixel value; and
a convolutional neural network including an input layer to which the correlation image is input and an output layer that outputs a distance-related parameter related to a distance between the operation surface and the pointer.
